(19) United States
(12) Patent Application Publication
(10) Pub. No.: US 2024/0311145 A1
(43) Pub. Date: Sep. 19, 2024

(54) BINARY CODE SIMILARITY DETECTION DEVICE AND METHOD

(71) Applicants: SEOUL NATIONAL UNIVERSITY R&DB FOUNDATION, Seoul (KR); RESEARCH & BUSINESS FOUNDATION SUNGKYUNKWAN UNIVERSITY, Suwon-si (KR)

(72) Inventors: Yunheung PAEK, Seoul (KR); Hyungjoon KOO, Suwon-si (KR); Sunwoo AHN, Seoul (KR); Seonggwan AHN, Seoul (KR)

(73) Assignees: SEOUL NATIONAL UNIVERSITY R&DB FOUNDATION, Seoul (KR); RESEARCH & BUSINESS FOUNDATION SUNGKYUNKWAN UNIVERSITY, Suwon-si (KR)

(21) Appl. No.: 18/596,194

(22) Filed: Mar. 5, 2024

(30) Foreign Application Priority Data
Mar. 17, 2023 (KR) 10-2023-0035069

(51) Int. Cl. G06F 8/75

(52) U.S. Cl. CPC G06F 8/751

(57) ABSTRACT

A binary code similarity detection device performs a preprocessing operation of generating an assembly expression for the binary code by converting a machine language of an input binary code into an assembly language, extracting an assembly function or a command from the binary code converted to the assembly language, and detects a similarity to the assembly expression of a pre-stored binary code by inputting the assembly expression generated by the preprocessing operation to a trained model based on bidirectional encoder representations from transformers (BERT), and the trained model is generated by performing a pre-training step of causing the assembly expression to be understood and a fine-tuning step of inputting an assembly expression of a first binary code and an assembly expression of a second binary code to a pre-trained model and then fine-tuning the pre-trained model based on a similarity between the first binary code and the second binary code.

### CROSS-REFERENCE TO RELATED APPLICATION

This application is based on and claims priority under 35 U.S.C. § 119 to Korean Patent Application No. 10-2023-0035069, filed on Mar. 17, 2023, in the Korean Intellectual Property Office, the disclosure of which is incorporated by reference herein in its entirety.

### BACKGROUND

The present disclosure relates to a binary code similarity detection device and method.

Recently, a market size of open source used to develop computer programs has been growing day by day. As the size and complexity of a computer program code increase, code reuse has become an essential element in code writing. Accordingly, the use of open source is also greatly increasing. However, when there is a threat in open source code, the threat may be planted in many binary codes without being recognized by a developer, resulting in a fatal security issue. Also, when open source code potentially infringes someone else's copyright or patent rights, using the open source code without recognizing this may result in infringement of the copyright or patent rights.

Binary similarity detection technology is a technology of detecting whether important code fragments, such as functions with vulnerabilities or functions protected by copyright/patent rights, exist in the binary to be inspected. It is difficult to analyze binary code because the binary code focuses on computer performance rather than human readability, but thanks to the recent rapid development of deep learning, research on deep learning-based binary similarity detection technology is underway.

In order to further increase the performance of previous studies, the present disclosure proposes a binary code similarity detection technology using a trained model based on bidirectional encoder representations from transformers (BERT).

A patent literature of the related art includes Korean Patent No. 10-2318714 (Title of invention: COMPUTET PROGRAM FOR DETECTING SOFTWARE VULNERABILITY BASED ON BINARY CODE CLONE)

### SUMMARY

The present disclosure provides a device and method for detecting similarity of binary code through a trained model based on BERT.

Technical objects to be achieved by the present embodiments are not limited to the technical object described above, and there may other technical objects.

According to a first aspect of the present disclosure, a binary code similarity detection device includes a memory storing a binary code similarity detection program, and a processor configured to execute the binary code similarity detection program, wherein the binary code similarity detection program performs a preprocessing operation of generating an assembly expression for the binary code by converting a machine language of an input binary code into an assembly language, extracting an assembly function or a command from the binary code converted to the assembly language, and detects a similarity to the assembly expression of a pre-stored binary code by inputting the assembly expression generated by the preprocessing operation to a trained model based on bidirectional encoder representations from transformers (BERT), and the trained model is generated by performing a pre-training step of causing the assembly expression to be understood and a fine-tuning step of inputting an assembly expression of a first binary code and an assembly expression of a second binary code to a pre-trained model and then fine-tuning the pre-trained model based on a similarity between the first binary code and the second binary code.

According to a second aspect of the present disclosure, a binary code similarity detection method using a binary code similarity detection device includes performing a preprocessing operation of generating an assembly expression for the binary code by converting a machine language of an input binary code into an assembly language, extracting an assembly function or a command from the binary code converted to the assembly language; and detecting a similarity to the assembly expression of a pre-stored binary code by inputting the assembly expression generated by the preprocessing operation to a trained model based on bidirectional encoder representations from transformers (BERT), wherein the trained model is generated by performing a pre-training step of causing the assembly expression to be understood and a fine-tuning step of inputting an assembly expression of a first binary code and an assembly expression of a second binary code to a pre-trained model and then fine-tuning the pre-trained model based on a similarity between the first binary code and the second binary code.

### BRIEF DESCRIPTION OF THE DRAWINGS

Embodiments of the inventive concept will be more clearly understood from the following detailed description taken in conjunction with the accompanying drawings in which:

FIG. 1 is a block diagram illustrating a configuration of a binary code similarity detection device according to an embodiment of the present disclosure;

FIGS. 2, 3, 4, and 5 are diagrams illustrating a main configuration of a binary code similarity detection program according to an embodiment of the present disclosure;

FIG. 6 is a diagram illustrating a normalization result according to an embodiment of the present disclosure; and

FIG. 7 is a flowchart illustrating a binary code similarity detection process using a BERT model, according to an embodiment of the present disclosure.

### DETAILED DESCRIPTION OF THE EMBODIMENTS

Hereinafter, embodiments of the present disclosure will be described in detail such that those skilled in the art to which the present disclosure belongs may easily implement the present disclosure with reference to the accompanying drawings. However, the present disclosure may be implemented in many different forms and is not limited to the embodiments to be described herein. In addition, in order to clearly describe the present disclosure with reference to the drawings, portions irrelevant to the description are omitted, and similar reference numerals are attached to similar portions throughout the specification.

When it is described that a portion is “connected” to another portion throughout the specification, this includes not only a case where the portion is “directly connected” to another portion but also a case where the portion is “indirectly connected” to another portion with another component therebetween.

When it is described that a member is “on” another member throughout the specification, this includes not only a case where a member is in contact with another member, but also a case where there is another member between the two members.

Hereinafter, embodiments of the present disclosure are described in detail with reference to the attached drawings.

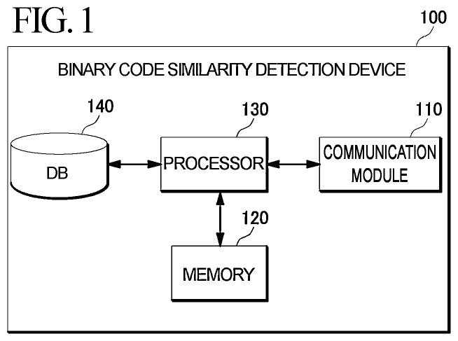

FIG. 1 is a block diagram illustrating a configuration of a binary code similarity detection device according to an embodiment of the present disclosure.

A binary code similarity detection device 100 includes a communication module 110, a memory 120, a processor 130, and a database (DB) 140.

The binary code similarity detection device 100 preprocesses an input binary code and then inputs the binary code into a trained model based on bidirectional encoder representations from transformers (BERT) to detect similarity with an assembly expression of the pre-stored binary code. The binary code similarity detection device 100 may be implemented by a computer or mobile terminal that may access a network. Here, the computer may include, for example, a laptop computer, a desktop computer, or so on, and the mobile terminal is, for example, a wireless communication device that ensures portability and mobility which includes all types of handheld-based wireless communication devices, such as various smartphones, tablet personal computers (PCs), and smartwatches.

Also, the binary code similarity detection device 100 may function as a server that provides a binary code similarity detection result to an external computing device, and in this case, the server operates in a cloud computing service model, such as software as a service (SaaS), platform as a service (PaaS), or infrastructure as a service (laaS), or laaS (Infrastructure as a Service), or may be built in a form, such as a private cloud, a public cloud, or a hybrid cloud.

The communication module 110 receives a binary code from an external computing device. In this case, the binary code may be used as training data in the process of building a trained model or may be used as input data input to the trained model. The communication module 110 may be a device that includes hardware and software required to transmit and receive signals, such as control signals or data signals through wired or wireless connections with other network devices.

A binary code similarity detection program may be stored in the memory 120. The binary code similarity detection program may be executed by the processor 130 and may performs a preprocessing operation of converting a machine language of the input binary code into an assembly language, extracting an assembly function or commands from the binary code converted to the assembly language, and generating an assembly expression for the binary code. In addition, the binary code similarity detection program may input the assembly expression generated according to the preprocessing operation to a trained model based on BERT to detect similarity with the assembly expression of the pre-stored binary code. In addition, the BERT-based trained model is generated by performing a pre-training step of causing the assembly expression to be understood and a step of inputting an assembly expression of the first binary code and an assembly expression of the second binary code to a pre-trained model and then fine-tuning the pre-trained model based on a similarity between the first binary code and the second binary code. The preprocessing operation and a trained model construction process will be described below in detail.

In addition, the memory 120 should be interpreted as including a nonvolatile storage device that continuously maintain the stored information even when power is not supplied and a volatile storage device that requires power to maintain the stored information. The memory 120 may include magnetic storage media or flash storage media in addition to the volatile storage device that requires power to maintain the stored information, but the scope of the present disclosure is not limited thereto.

The processor 130 may control a general computation operation of the binary code similarity detection device 100, for example, an operation of executing an operating system, managing data received from an external device through the interface module 110, or so on. Also, the processor 130 starts execution of a binary code similarity detection program stored in the memory 120 according to a manager's execution request, and transmits an execution result of the binary code similarity detection program to an external device through the communication module 110.

The processor 130 may include all types of devices that may process data. For example, the process 130 may refer to a data processing device that includes a physically structured circuit to perform a function expressed by a code or commands included in a program and is built in hardware. The data processing device built in hardware may include a microprocessor, a central processing unit (CPU), a processor core, a multiprocessor, an application-specific integrated circuit (ASIC), a field programmable gate array (FPGA), or so on, but the scope of the present disclosure is not limited thereto.

The database 140 stores or provides data necessary for the binary code similarity detection device 100 under control by the processor 130. For example, the database 140 may store a binary code with detected vulnerabilities or a binary code protected by copyright/patent rights or so on, store assembly expressions such as assembly functions or commands generated after preprocessing each binary code, or store an embedding vector representing characteristics of the assembly expression. Also, the database 140 may store a similarity detection result of the binary code generated by execution of a binary code similarity detection program. This database 140 may be included as a separate component from the memory 120 or may be built in a partial area of the memory 120.

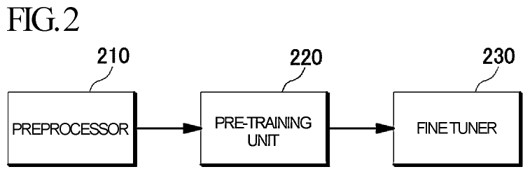

FIGS. 2 to 5 are diagrams illustrating a main configuration of a binary code similarity detection program according to an embodiment of the present disclosure.

Referring to FIG. 2, the binary code similarity detection program includes a preprocessor 210, a pre-training unit 220, and a fine tuner 230, and generates a trained model based on BERT by using the preprocessor 210, the pre-training unit 220, and the fine tuner 230. Also, the binary code similarity detection program includes a predictor 240, and the predictor 240 performs similarity detection of a binary code by using a trained model.

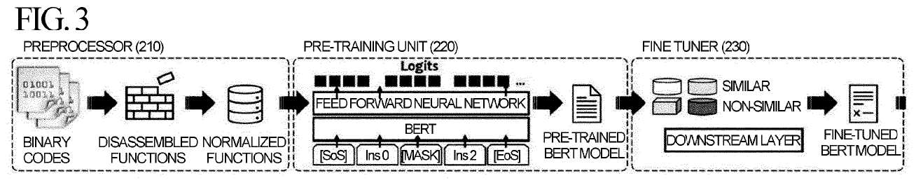

Referring to FIG. 3, the preprocessor 210 converts a machine language of the input binary code into an assembly language. To this end, the preprocessor 210 converts a machine language into an assembly language by using a known disassembler. Then, the preprocessor 210 extracts an assembly function or a command from the binary code converted into the assembly language and generates an assembly expression for the binary code. To this end, the preprocessor 210 recognizes the assembly function as a sentence and the command a word through normalization, and deletes elements unnecessary for training.

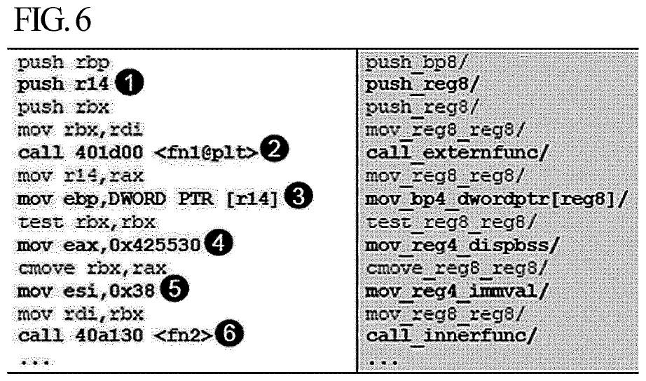

FIG. 6 is a diagram illustrating a normalization result, where a left side illustrates codes before normalization, and a right side illustrates codes after normalization. For example, normalization may be performed by deleting information that is not helpful in understanding an operation of a corresponding function while a range of possibility of modification is too large like a function name fn1@plt of a command number 2 on the left in FIG. 6 and modifying “call fn1@plt” to “call_externfunc” on the right. The normalization may be performed by a code normalization program automated according to a preset rule, and an open source code for performing the function is also known, and accordingly, detailed descriptions thereof are omitted.

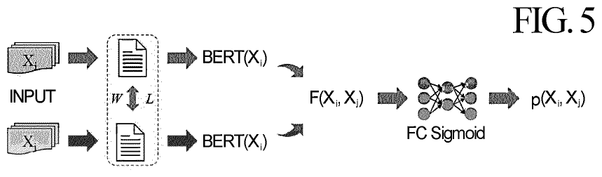

Next, referring to FIGS. 3 and 5, the pre-training unit 220 replaces some words in the assembly expression with mask words according to a BERT model construction method and matches the words before replacing them with the mask words and performs masked language modeling (MLM) training to match words before replacing with mask words. In an MLM training process, BERT is trained by replacing some words in the assembly expression with a special word called “MASK” and then match the words before being replaced through BERT. In this process, training is performed to understand a context of sentences, which trains BERT to understand the language itself.

For reference, BERT is known as a training method of training a language model by using a large amount of unlabeled pre-training data and adding a neural network for a specific task (document classification, question answering, translation, and so on) based thereon. A construction process of the BERT model includes a pre-training process in which a large encoder models a language by embedding input sentences, and a process of performing various types of natural language processing by performing fine-tuning.

The fine tuner 230 fine-tunes the pre-trained trained model through a downstream layer. As illustrated in FIG. 5, the downstream layer constructs a first pre-trained model and fine-tunes the first pre-trained model and the second pre-trained model based on a similarity between a first embedding vector output by inputting an assembly expression of a first binary code to the first pre-trained model and a second embedding vector output by inputting an assembly expression of a second binary code to the second pre-trained model. In this case, the first pre-trained model and the second pre-trained model share weights and correspond to the same pre-trained model.

For reference, the Siamese neural network is a network that is trained by vectorizing two different inputs using a pre-trained model that shares parameters, reducing a distance between two vectors when the two inputs are similar to each other, and increasing the distance between the two vectors when the two inputs are different from each other. Important selection factors for the Siamese neural network are a model for vectorization, a distance function, and an objective function. In the present disclosure, the model for vectorization is the pre-trained model described above. A cosine similarity function or a weighted distance vector may be used as a distance function. In a case of the weighted distance vector, a relationship between respective elements may be identified and reflected in the similarity, allowing the relationship between the two functions to be trained more carefully. Binary cross entropy may be used as the objective function.

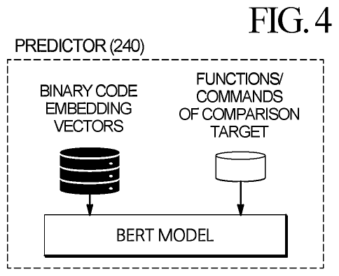

Referring to FIG. 4, the predictor 240 inputs the assembly expression of the input binary code to the BERT model trained through the pre-training unit 220 and the fine tuner 230 described above and detects similarity to the assembly expression of pre-stored binary code. In this case, the assembly expression of the input binary code is preprocessed by the preprocessor 210. That is, a plurality of assembly expressions obtained by dividing the binary code are generated through preprocessing and are compared with the assembly expression of the binary code pre-stored in the database, and thereby, similarity detection is performed.

Because the BERT model is fine-tuned through the Siamese neural network in the fine-tuning processing after pre-training, the predictor 240 inputs the assembly expression of the input binary code and the assembly expression of the pre-stored binary code of a comparison target to a downstream layer and calculates similarity between respective assembly expressions.

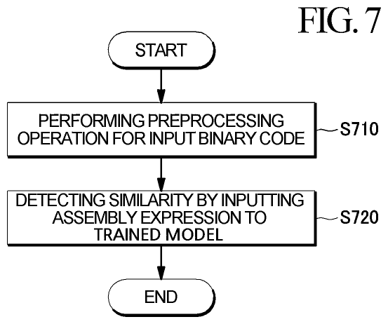

FIG. 7 is a flowchart illustrating a similarity detection process of a binary code using a BERT model, according to an embodiment of the present disclosure.

First, when receiving a binary code of a detection target, the binary code similarity detection device 100 performs a preprocessing operation on the binary code (S710).

In the preprocessing operation, a machine language of the input binary code is converted into an assembly language, an assembly function or a command are extracted, and an assembly expression for the binary code is generated. To this end, the assembly function is recognized as a sentence and the command is recognized as a word through normalization, and elements unnecessary for training are deleted.

Next, the binary code similarity detection device 100 inputs the assembly expression generated according to the preprocessing operation to the BERT model and detects a similarity to an assembly expression of the pre-stored binary code (S720).

In this case, the trained model is formed by performing a pre-training step of causing the assembly expression to be understood and a step of fine-tuning the pre-trained model. In this case, the trained model is fine-tuned to output a similarity between an assembly expression of a first binary code and an assembly expression of a second binary code by using a Siamese neural network. Accordingly, the binary code similarity detection device 100 may output the similarity between the assembly expression of the input binary code and the assembly expression of the pre-stored binary code.

According to the present disclosure, it is possible to efficiently detect a binary code including a function with vulnerability or a code protected by copyright/patent rights.

A method of detecting similarity of binary code according to one embodiment of the present disclosure may be implemented in the form of a recording medium including commands executable by a computer, such as a program module executed by a computer. A computer readable medium may be any available medium that may be accessed by a computer and includes both volatile and nonvolatile media, removable and non-removable media. Also, the computer readable medium may include a computer storage medium. A computer storage medium includes both volatile and nonvolatile media and removable and non-removable media implemented by any method or technology for storing information, such as computer readable commands, data structures, program modules or other data.

Although the method and system of the present disclosure are described with respect to specific embodiments, some or all of components or operations thereof may be implemented by using a computer system having a general-purpose hardware architecture.

The above descriptions of the present disclosure are for illustrative purposes only, and those skilled in the art to which the present disclosure belongs will understand that the present disclosure may be easily modified into another specific form without changing the technical idea or essential features of the present disclosure. Therefore, the embodiments described above should be understood as illustrative in all respects and not limiting. For example, each component described as a single type may be implemented in a distributed manner, and similarly, components described in a distributed manner may also be implemented in a combined form.

The scope of the present disclosure is indicated by the following claims rather than the detailed description above, and the meaning and scope of the claims and all changes or modifications derived from the equivalent concepts should be interpreted as being included in the scope of the present disclosure.

What is claimed is:

1. A binary code similarity detection device comprising:
a memory storing a binary code similarity detection program; and
a processor configured to execute the binary code similarity detection program,
wherein the binary code similarity detection program performs a preprocessing operation of generating an assembly expression for the binary code by converting a machine language of an input binary code into an assembly language and extracting an assembly function or a command from the binary code converted to the assembly language, and detects a similarity to the assembly expression of a pre-stored binary code by inputting the assembly expression generated by the preprocessing operation to a trained model based on bidirectional encoder representations from transformers (BERT), and
the trained model is generated by performing a pre-training step of causing the assembly expression to be understood and a fine-tuning step of inputting an assembly expression of a first binary code and an assembly expression of a second binary code to a pre-trained model and then fine-tuning the pre-trained model based on a similarity between the first binary code and the second binary code.

2. The binary code similarity detection device of claim 1, wherein
the binary code similarity detection program, in the pre-training step, replaces some words in the assembly expression with mask words and performs masked language modeling (MLM) training to match words before being replaced with the mask words.

3. The binary code similarity detection device of claim 1, wherein
the binary code similarity detection program, in the fine-tuning step, constructs a first pre-trained model and a second pre-trained model according to a Siamese neural network and fine-tunes the first pre-trained model and the second pre-trained model based on a similarity between a first embedding vector output by inputting the assembly expression of the first binary code to the first pre-trained model and a second embedding vector output by inputting the assembly expression of the second binary code to the second pre-trained model.

4. The binary code similarity detection device of claim 1, wherein
the binary code similarity detection program generates a plurality of assembly expressions obtained by dividing the binary code through the preprocessing operation for the input binary code and detects a similarity between respective assembly expressions and the assembly expression of the pre-stored binary code.

5. A binary code similarity detection method using a binary code similarity detection device, the binary code similarity detection method comprising:
performing a preprocessing operation of generating an assembly expression for the binary code by converting a machine language of an input binary code into an assembly language, extracting an assembly function or a command from the binary code converted to the assembly language; and
detecting a similarity to the assembly expression of a pre-stored binary code by inputting the assembly expression generated by the preprocessing operation to a trained model based on bidirectional encoder representations from transformers (BERT),
wherein the trained model is generated by performing a pre-training step of causing the assembly expression to be understood and a fine-tuning step of inputting an assembly expression of a first binary code and an assembly expression of a second binary code to a pre-trained model and then fine-tuning the pre-trained model based on a similarity between the first binary code and the second binary code.

6. The binary code similarity detection method of claim 5, wherein
in the pre-training step, replacing some words in the assembly expression with mask words, and performing masked language modeling (MLM) training to match words before being replaced with the mask words.

7. The binary code similarity detection method of claim 5, wherein,
in the fine-tuning step, constructing a first pre-trained model and a second pre-trained model according to a Siamese neural network, and fine-tuning the first pre-trained model and the second pre-trained model based on a similarity between a first embedding vector output by inputting the assembly expression of the first binary code to the first pre-trained model and a second embedding vector output by inputting the assembly expression of the second binary code to the second pre-trained model.

8. A computer program that is stored in a computer-readable storage medium and performs the binary code similarity detection method according to claim 5.

9. A non-transitory computer-readable recording medium in which a computer program for performing the binary code similarity detection method according to claim 5 is recorded.
